(19) United States
(12) Patent Application Publication
(10) Pub. No.: US 2011/0099273 A1
(43) Pub. Date: Apr. 28, 2011

(54) MONITORING APPARATUS, MONITORING METHOD, AND A COMPUTER-READABLE RECORDING MEDIUM STORING A MONITORING PROGRAM

(75) Inventors: Akira IDE, Kawasaki (JP); Kazuyuki Sakai, Kawasaki (JP); Yasushi Kobayashi, Kawasaki (JP); Yuuki Tada, Kawasaki (JP); Tomoyuki Kobayashi, Kawasaki (JP)

(73) Assignee: FUJITSU LIMITED, Kawasaki-shi (JP)

(21) Appl. No.: 12/909,009

(22) Filed: Oct. 21, 2010

(30) Foreign Application Priority Data
Oct. 22, 2009 (JP) 2009-243649

(51) Int. Cl. G06F 15/173

(52) U.S. Cl. 709/224

(57) ABSTRACT

A monitoring apparatus configured to monitor applications running on one or more monitored apparatuses; the monitoring apparatus includes: an enquiry packet generator and transmitter that generates multiple types of enquiry packets, and successively transmits the multiple types of enquiry packets to respective communication ports on the one or more monitored servers; an enquiry packet response receiver that receives enquiry packet responses, which are transmitted in response to the multiple types of enquiry packets from communication ports on the one or more monitored apparatuses; and an application analyzer that analyzes the content of the enquiry packet responses transmitted in response to the multiple types of enquiry packets, and analyzes applications running on the one or more monitored servers as applications to be monitored.

### CROSS-REFERENCE TO RELATED APPLICATIONS

This application is based upon and claims the benefit of priority of the prior Japanese Patent Application No. 2009-243649, filed on Oct. 22, 2009, the entire contents of which are incorporated herein by reference.

### FIELD

Embodiments herein relate to a monitoring apparatus, a monitoring method, and a monitoring program able to monitor conditions in monitored applications running on a monitored apparatus.

### BACKGROUND

Recently, networks such as the Internet are being utilized to provide a variety of IT services. Such IT services are realized by applications running on a plurality of servers connected to the network.

FIG. 1 illustrates an example configuration of an IT system that provides IT services. The IT system in FIG. 1 is based on a three-tier model. The IT system in FIG. 1 includes a plurality of Web servers 2, a plurality of application servers 3, a database server 4, and load balancers 5. Users use the IT system by connecting to a Web server 2 from a client 1. The IT system in FIG. 1 includes multiple Web servers 2 and application servers 3 for load distribution. Requests to the Web servers 2 and the application servers 3 are partitioned out by the load balancers 5.

FIG. 2 illustrates configurations of respective servers in a (three-tier model) IT system that provides IT services. The Web server 2, the application server 3, and the database server 4 each include hardware 11, with an OS 12 running on the hardware 11, and applications 13 running on the OS 12. For example, in the IT systems illustrated in FIGS. 1 and 2, the applications running on the plurality of servers communicate via a network, providing the value of the IT services.

FIG. 3 illustrates another example configuration of an IT system that provides IT services. The IT system in FIG. 3 is a cluster/redundant system. The IT system in FIG. 3 includes a cluster system 20. The cluster system 20 includes an operating primary node 21, a standby secondary node 22, and a shared disk 23.

Users use the IT system by connecting to a business application 24 on the primary node 21 from a client 1. In addition, communication programs that use IT services may also use the IT system by connecting to the business application 24 on the primary node 21. When a failure occurs in the primary node 21, the IT system in FIG. 3 can still continue to provide IT services by failing over to the secondary node 22. The primary node 21 and the secondary node 22 each have their own hardware, with an OS running on the hardware, and a business application 24 or 25 running on the OS. For example, in the IT system illustrated in FIG. 3, the applications running on the plurality of servers may communicate via a network and provide the value of the IT services.

FIG. 4 illustrates another example configuration of an IT system that provides IT services. The IT system in FIG. 4 is a virtualized system. The IT system in FIG. 4 includes a host server 30. The host server 30 uses virtualization technology to operate a plurality of virtual servers 33.

Users use the IT system by connecting to a business application 35 on a virtual server 33. In addition, communication programs that use IT services may also use the IT system by connecting to a business application 35 on a virtual server 33.

The host server 30 includes hardware, with an OS 31 running on the hardware, and a virtualization program 32 running on the OS 31. By means of the virtualization program 32 running on the host server 30, a plurality of virtual servers 33 are made to operate, with an OS 34 running on each of the plurality of virtual servers 33, and a business application 35 running on each OS 34. For example, in the IT system illustrated in FIG. 4, the applications running on the plurality of virtual servers may communicate via a network and provide the value of the IT services.

An IT system that provides IT services may also include combinations of the respective IT systems illustrated in FIGS. 1 to 4. The IT services provided by each IT system are collections of functions that support the business of users using IT, and it is expected that such IT services should be able to provide value with respect to user demands.

Thus, for the providers or users of IT services for business purposes, it is important to monitor IT systems to ensure that IT services are providing value as expected. In other words, it is important to monitor IT systems to ensure that systems built to provide a projected value are operating according to projections.

A business application that provides IT services may also be the combined result of individual programs (or processes). Herein, business applications to be monitored are assumed to belong to the following three types.

FIGS. 5A and 5B illustrate one example of a business application. FIG. 5A represents a business application 41 that runs independently. The business application 41 illustrated in FIG. 5A may be, for example, a Telnet server, an FTP server, an application that constitutes a business system for per-customer accounts and purchases or other functions, a tool for user-generated content, or a retail software package.

FIG. 5B represents a business application 42 that runs on a base application 43. The business application 42 illustrated in FIG. 5B may be, for example, software that runs on an application server, or a wiki or other software that runs on a Web server. Herein, the term “instance” is used to refer to an application running on the base application 43.

Besides the above, the business application may also be a base application 43 that actually provides the IT services, such as an application server, a Web server, or a database server.

In the past, the following two methods existed for monitoring business applications for IT services. FIG. 6 is a diagram for explaining one example of a method for monitoring business applications for IT services. The method in FIG. 6 involves the following: implementing software 54 (i.e., monitoring software) for monitoring target servers 52 (i.e., the monitored servers) that run the business application 55; and also implementing monitoring software 53 for monitoring the server 51 (i.e., the monitoring server) that monitors the business application 55 on the monitored servers 52.

Herein, the monitoring software 53 on the monitoring server 51 is referred to as the manager, while the monitoring software 54 on the monitored servers 52 is referred to as the agent. The monitoring software 53 and 54 detect/monitor the processes and instances that constitute the business application 55.

Meanwhile, FIG. 7 is a diagram for explaining another example of a method for monitoring business applications for IT services. The method in FIG. 7 involves remotely detecting/monitoring the processes and instances that constitute the business application 55 from the monitoring server 51, without implementing monitoring software 54 on the monitored servers 52. In order to remotely detect/monitor the processes and instances that constitute the business application 55 from the monitoring server 51, Telnets 56 and 57 are used in the monitoring server 51 and the monitored servers 52.

In addition, applications running on a plurality of servers in the related art have also monitored faults such as response delays (see, for example, Japanese Unexamined Patent Application Publication No. 2006-65619).

In the related art, problems such as the following exist in the above methods for monitoring business applications for IT services.

In the method illustrated in FIG. 6, monitoring software 54 is implemented on the monitored servers 52, and the processes and instances that constitute the business application 55 are detected/monitored by running the monitoring software 54. However, this method requires the implementation of monitoring software 54 on all monitored servers 52.

Given the cluster system 20 in FIG. 3, the above method would require respectively implementing monitoring software 54 on both the operating primary node 21 as well as the standby secondary node 22. Given the virtualized system in FIG. 4, the above method would require implementing monitoring software 54 on each of the virtual servers 33.

Furthermore, if monitoring software 54 is implemented on the monitored servers 52, and if the processes and instances that constitute the business application 55 are detected/monitored by running the monitoring software 54 according to the method in FIG. 6, then in some cases IT system downtime might occur for matters that are related to the implementation and upkeep of the monitoring software 54, and completely unrelated to regular system operation.

Meanwhile, in the method illustrated in FIG. 7, the processes and instances that constitute the business application 55 are remotely detected/monitored from the monitoring server 51, without implementing monitoring software 54 on the monitored servers 52. However, this method requires configuring the servers with advance settings necessary to conduct remote operations. Such advance settings necessary to conduct remote operations may involve opening ports used by remote commands in protocols such as Telnet and SSH. Also, such advance settings necessary to conduct remote operations may involve setting up access accounts (consistent for all agents) for conducting remote operations. For these reasons, the above method has security risks.

Additionally, the above methods for monitoring business applications for IT services monitor IT service business applications by periodically checking the existence of pre-defined processes. For this reason, it is necessary for the system administrator to define in advance the processes that constitute the business applications for IT services.

If the system administrator has a detailed understanding of the IT services configuration, then the processes that constitute the business applications for IT services can be defined manually. Also, even if business applications are statically assigned to servers according to system conditions, the system administrator should have an understanding of such assignments, and be able to manually define the processes that constitute the business applications.

However, in the cases of the IT systems illustrated in FIGS. 1, 3, and 4, the IT services configuration (i.e., the relationship between business applications and processes, and the relationship between business applications and servers) dynamically changes. For this reason, manually defining processes is extremely difficult for large-scale IT system environments, and for environments wherein a plurality of IT systems have been combined.

Thus, as described above, such methods for monitoring business applications for IT services cannot be used to easily monitor business applications for IT services.

### SUMMARY

According to an aspect of the invention, a monitoring apparatus configured to monitor applications running on one or more monitored apparatuses; the monitoring apparatus includes: an enquiry packet generator and transmitter that generates multiple types of enquiry packets, and successively transmits the multiple types of enquiry packets to respective communication ports on the one or more monitored servers; an enquiry packet response receiver that receives enquiry packet responses, which are transmitted in response to the multiple types of enquiry packets from communication ports on the one or more monitored apparatuses; and an application analyzer that analyzes the content of the enquiry packet responses transmitted in response to the multiple types of enquiry packets, and analyzes applications running on the one or more monitored servers as applications to be monitored.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example configuration of an IT system that provides IT services;

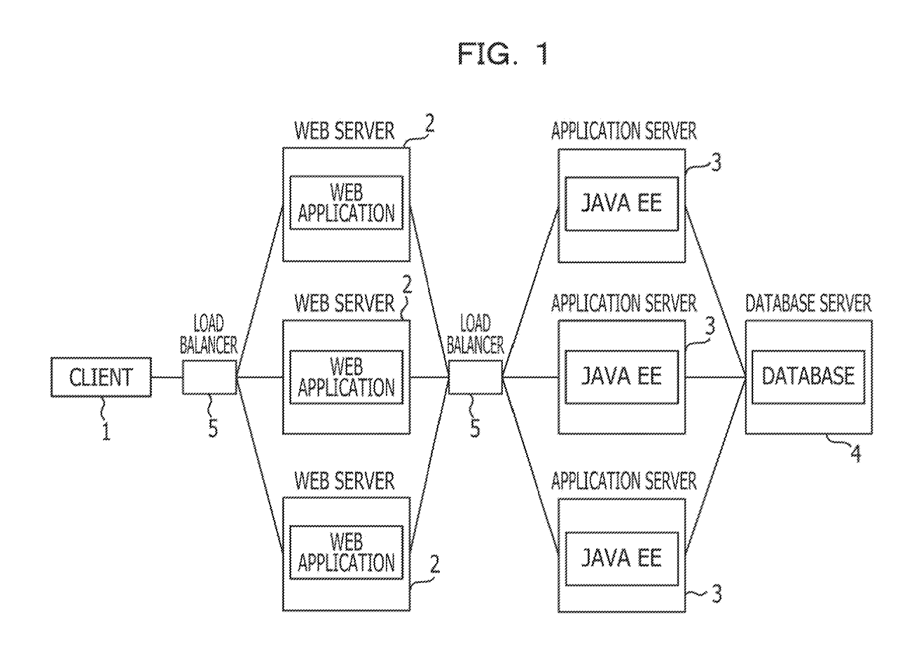

FIG. 2 illustrates configurations of respective servers in a (three-tier model) IT system that provides IT services;

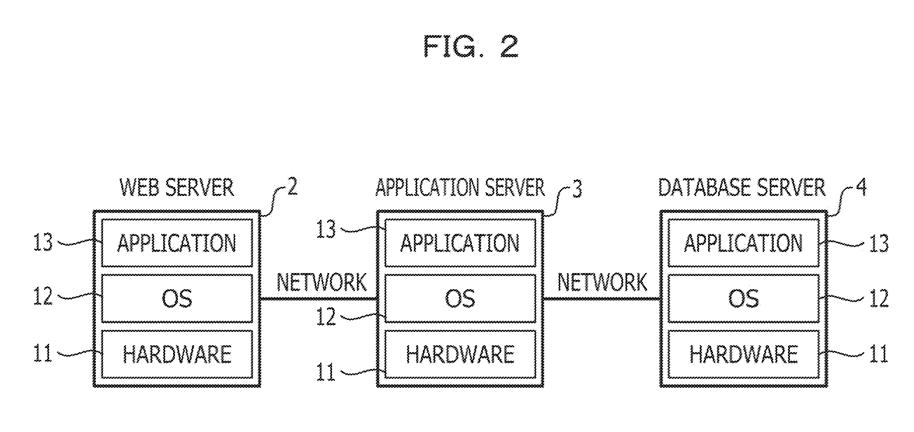

FIG. 3 illustrates another example configuration of an IT system that provides IT services;

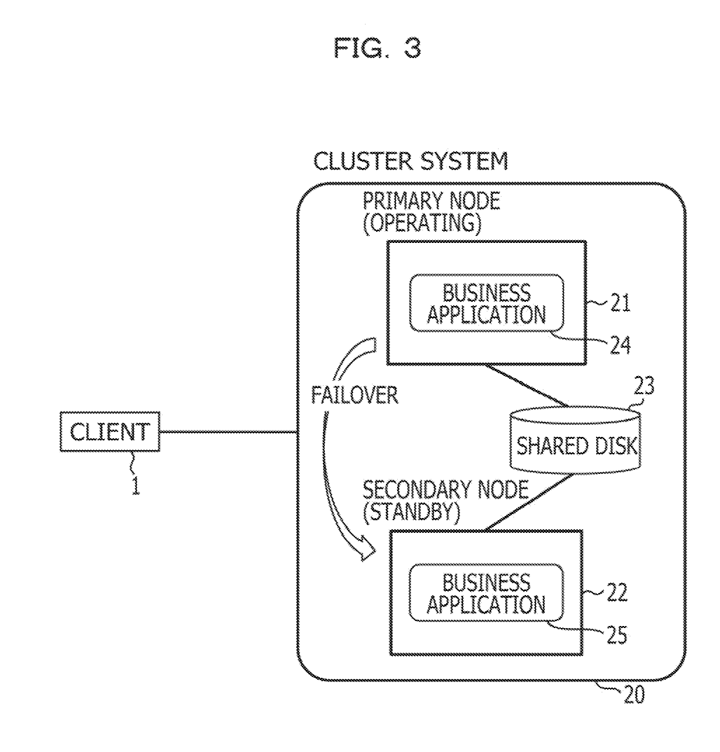

FIG. 4 illustrates another example configuration of an IT system that provides IT services;

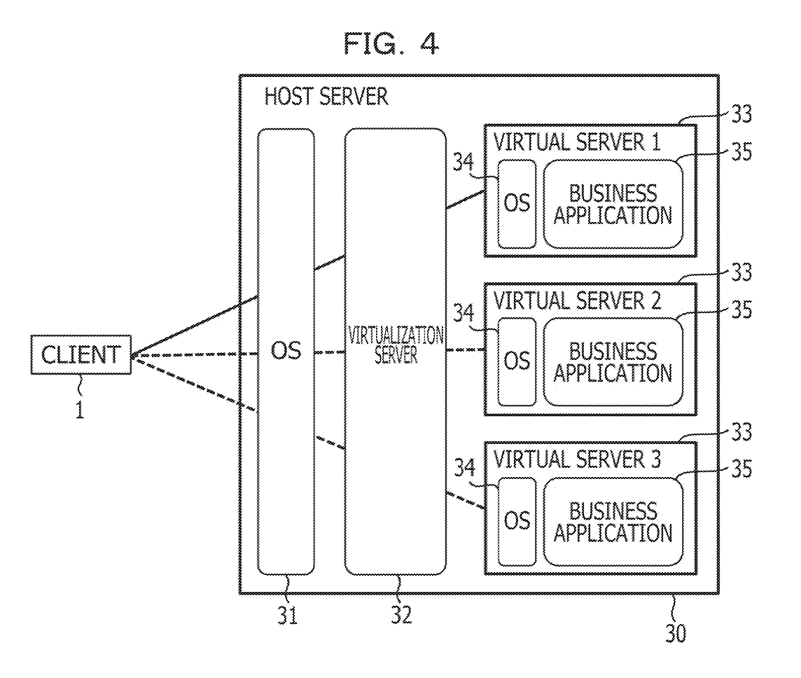

FIGS. 5A and 5B illustrate one example of a business application;

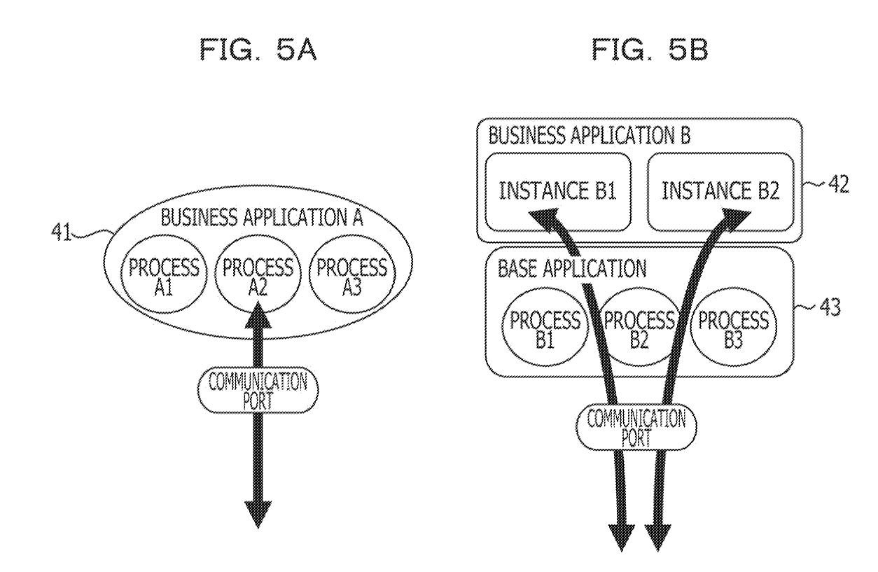

FIG. 6 is a diagram for explaining one example of a method for monitoring business applications for IT services;

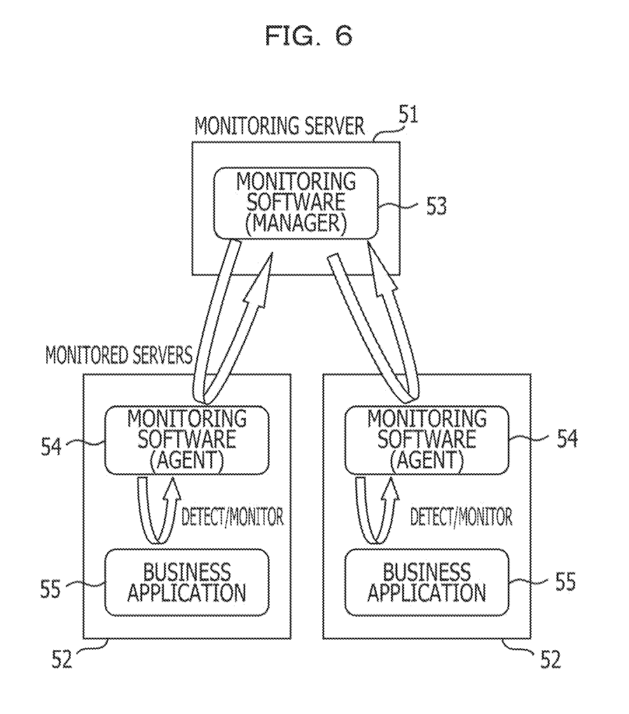

FIG. 7 is a diagram for explaining another example of a method for monitoring business applications for IT services;

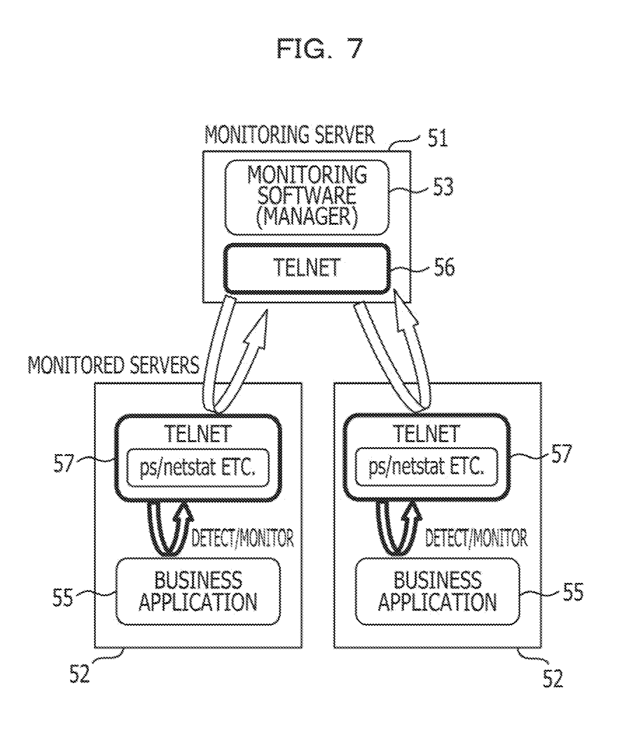

FIG. 8 illustrates one example configuration of an IT system that includes a monitoring server in accordance with an embodiment;

FIG. 9 illustrates an example of a hardware configuration of a computer system that realizes a monitoring server;

FIG. 10 is an example flowchart representing processing operations in a monitored application table generation phase;

FIG. 11 is an example flowchart representing processing operations in an application operation monitoring phase;

FIG. 12 is the first part (1/2) of an example flowchart representing detailed processing operations in a monitored application table generation phase;

FIG. 13 is the second part (2/2) of an example flowchart representing detailed processing operations in a monitored application table generation phase;

FIG. 14 illustrates the structure of data expressing an enquiry packet for a lower-layer network protocol;

FIG. 15 illustrates a response to an enquiry packet;

FIG. 16 illustrates an example of processing operations for generating a monitored application table when a first enquiry packet is transmitted;

FIG. 17 is an example of a table indicating the content of the data portion of an enquiry packet for various network protocols;

FIG. 18 is an example of a table illustrating the content of an enquiry packet response for various combinations of enquiry packet network protocols and target applications (i.e., applications using particular port numbers);

FIG. 19 illustrates an example of processing operations for generating a monitored application table when second and third enquiry packets are transmitted;

FIG. 20 illustrates one example of a monitored application table;

FIG. 21 is an example flowchart representing detailed processing operations in an application operation monitoring phase;

FIG. 22 illustrates an example structure of a management table managed by monitoring software;

FIG. 23 illustrates an example of how an operating application table and snapshots change for a monitored server A;

FIG. 24 illustrates a schematic example of grouping monitored servers; and

FIG. 25 illustrates an example representation of a screen for notifying an administrator of operational irregularities in applications.

### DESCRIPTION OF EMBODIMENTS

It is desirable to provide a monitoring apparatus, a monitoring method, and a monitoring program able to easily monitor conditions in monitored applications running on a monitored apparatus, and without implementing monitoring programs on the monitored apparatus.

The following embodiments will be described with reference to the accompanying drawings. Embodiments are described by taking a monitoring server as one example of a monitoring apparatus.

(System Configuration)

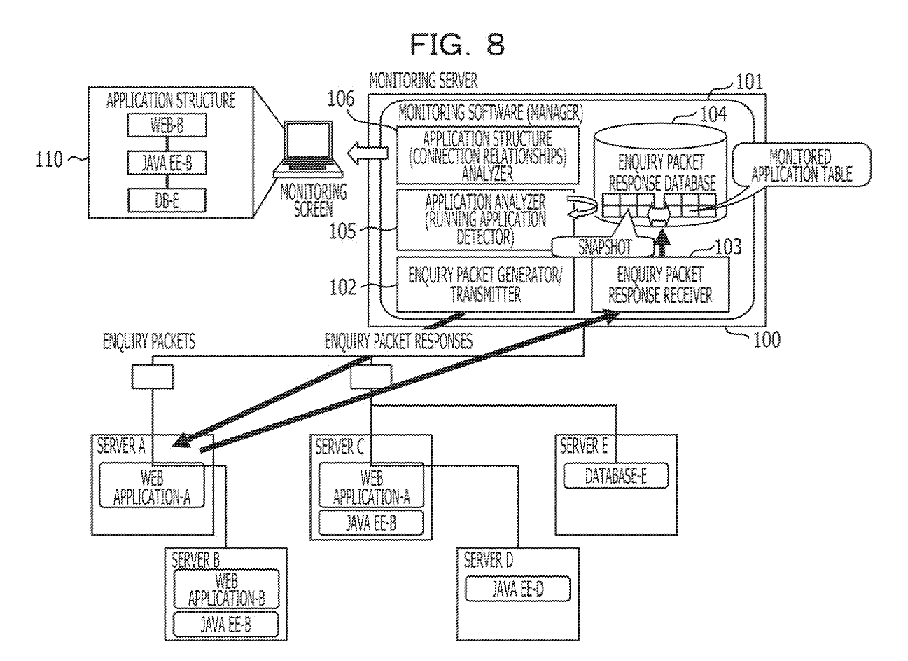

FIG. 8 illustrates an example configuration of an IT system that includes a monitoring server in accordance with an embodiment. In the IT system illustrated in FIG. 8, a monitoring server 100 and servers A to E targeted for monitored (i.e., operating servers) are communicably coupled via a network such as the Internet or a LAN so as to enable data communication.

The monitoring server 100 includes monitoring software 101 (i.e., a manager). The monitoring software 101 is given as one example of a monitoring program. In addition, the monitoring software 101 includes an enquiry packet generator/transmitter 102, an enquiry packet response receiver 103, an enquiry packet response database 104, an application analyzer (i.e., an operating application detector) 105, and an application structure (i.e., connection relationships) analyzer 106. The application structure analyzer 106 is a built-in function of the monitoring software 101.

The enquiry packet generator/transmitter 102 generates an enquiry packet, to be described below, and then transmits the enquiry packet to the servers A to E. The enquiry packet response receiver 103 receives responses to the enquiry packets from the servers A to E (i.e., enquiry packet responses). The enquiry packet response receiver 103 records the received enquiry packet responses in a monitored application table in the enquiry packet response database 104. The enquiry packet response database 104 also stores snapshots, to be described later.

By utilizing the enquiry packet response database 104, the application analyzer 105 analyzes applications running on the servers A to E, the manner of this analysis will be described later. When a user specifies a server for application structure analysis, the application structure analyzer 106 utilizes the enquiry packet response database 104 to analyze the structure of applications running on the specified server, and displays the analysis results on a monitoring screen 110.

(Hardware Configuration of Monitoring Server 100)

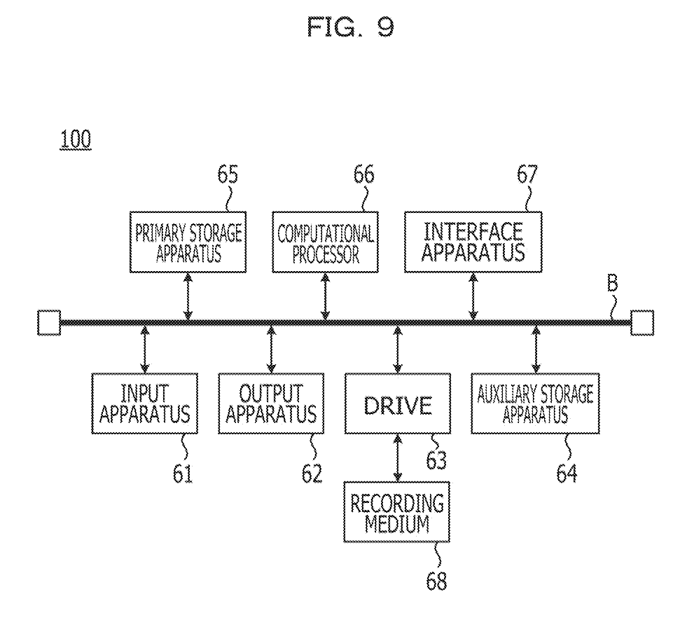

The monitoring server 100 is implemented as a result of executing a monitoring program in accordance with an embodiment on a computer system like that illustrated in FIG. 9. FIG. 9 illustrates an example of a hardware configuration of a computer system that implements a monitoring server.

The monitoring server 100 illustrated in FIG. 9 includes the following components, each respectively coupled to a bus B: a input apparatus 61, an output apparatus 62, a drive 63, an auxiliary storage apparatus 64, a primary storage apparatus 65, a computational processor 66, and an interface apparatus 67.

The input apparatus 61 may include devices such as a keyboard and mouse. The input apparatus 61 is used to input various signals. The output apparatus 62 may include devices such as a display. The output apparatus 62 is used to display various windows, data, and other information. The interface apparatus 67 may include devices such as a modem and LAN card. The interface apparatus 67 is used to connect to a network.

In accordance with an embodiment, a monitoring program is at least one part of various programs that control the monitoring server 100. The monitoring program may be provided by distribution on a recording medium 68, or by operations such as downloading from a network, for example.

A recording medium 68 used to store the monitoring program may be one of various types of recording media, including: a recording medium that optically, electrically, or magnetically records information, such as a CD-ROM, flexible disk, or magneto-optical disc; or semiconductor memory that electrically records information, such as ROM or flash memory.

When a recording medium 68 storing the monitoring program is placed into the drive 63, the monitoring program is installed from the recording medium 68 onto the auxiliary storage apparatus 64 via the drive 63. A monitoring program that has been downloaded from a network is installed onto the auxiliary storage apparatus 64 via the interface apparatus 67.

In addition to storing an installed monitoring program, the auxiliary storage apparatus 64 also stores the necessary files, data, and other information. The primary storage apparatus 65 reads and stores the monitoring program from the auxiliary storage apparatus 64. Subsequently, the computational processor 66 follows the monitoring program stored in the primary storage apparatus 65, and thereby implements the various processing blocks of the monitoring software 101 illustrated in FIG. 8.

The monitoring of business applications by the monitoring software 101 includes the following two phases: a monitored application table generation phase, and an application operation monitoring phase. The monitored application table generation phase and the application operation monitoring phase will be described as follows.

(Overview of Monitored Application Table Generation Phase)

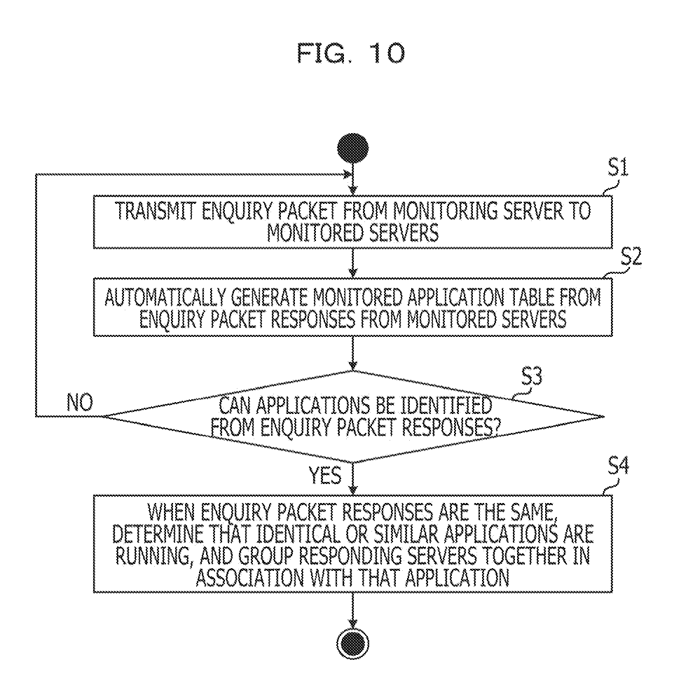

FIG. 10 is an example flowchart representing processing operations in a monitored application table generation phase. In operation 51, the enquiry packet generator/transmitter 102, which will be described below, generates an enquiry packet, and then transmits the enquiry packet to the servers A to E. Information regarding the servers A to E that are to receive the enquiry packet is obtained by the enquiry packet generator/transmitter 102 from a server list table which will be described below. The enquiry packet is comprehensively transmitted to respective communication ports of the servers A to E in a manner to be hereinafter described.

Proceeding to operation S2, the enquiry packet response receiver 103 receives enquiry packet responses from respective communication ports on the servers A to E (i.e., the monitored servers). An enquiry packet response may contain a normal response or an abnormal response (such as no message, no response, or an error). The enquiry packet response receiver 103 automatically generates a monitored application table from the received enquiry packet responses, and records the monitored application table in the enquiry packet response database 104.

Proceeding to operation S3, the application analyzer 105 determines whether or not applications running on the servers A to E can be identified from the enquiry packet responses. A description of how applications are identified from enquiry packet responses will be given later. If there are respective communication ports on the servers A to E for which applications cannot be identified from enquiry packet responses, then the application analyzer 105 requests the enquiry packet generator/transmitter 102 to transmit the next enquiry packet to respective communication ports on the servers A to E.

Returning to operation S1, the enquiry packet generator/transmitter 102 generates the next enquiry packet, and then transmits the next enquiry packet to the respective communication ports on the servers A to E for which applications could not be identified. The processing in operations S1 to S3 are repeated until applications can be identified from the received enquiry packet responses.

Once applications can be identified from all received enquiry packet responses, the process proceeds to operation S4. In operation S4, the application analyzer 105 determines that identical or similar applications are running when the enquiry packet responses are the same, and manages such applications as a group by associating the applications with the one or more servers that replied with those enquiry packet responses.

(Overview of Application Operation Monitoring Phase)

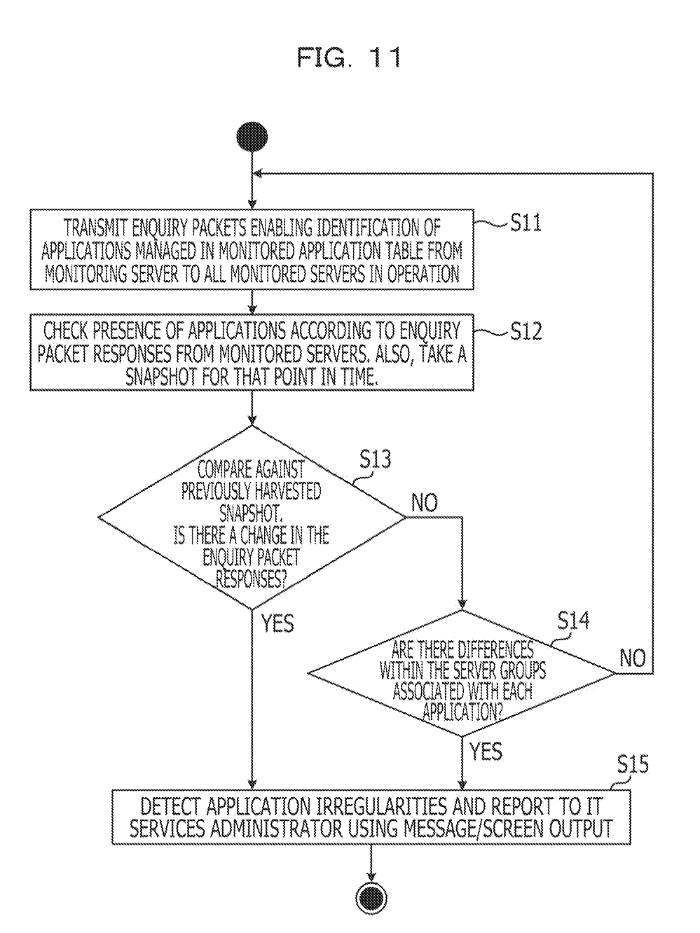

FIG. 11 is an example of a flowchart representing processing operations in an application operation monitoring phase. The application operation monitoring phase is conducted at predetermined intervals. In operation S11, the application analyzer 105 requests the enquiry packet generator/transmitter 102 to transmit particular enquiry packets to communication ports on the servers A to E, wherein the particular enquiry packets enable identification of applications running on the servers A to E managed by the monitored application table. The enquiry packet generator/transmitter 102 then transmits enquiry packets on the basis of the request from the application analyzer 105.

Proceeding to operation S12, the enquiry packet response receiver 103 receives enquiry packet responses from communication ports on the servers A to E. The enquiry packet response receiver 103 records the received enquiry packet responses in the enquiry packet response database 104. The application analyzer 105 then checks whether or not particular applications are present on the servers A to E according to the enquiry packet responses recorded in the enquiry packet response database 104. A description of how the presence of particular applications is checked from enquiry packet responses will be given later. The application analyzer 105 then records a snapshot of the applications running on the servers A to E at that time. The snapshot is recorded in the form of a running application table.

Proceeding to operation S13, the application analyzer 105 compares enquiry packet responses received by the enquiry packet response receiver 103 to the previously acquired snapshot, and determines whether or not any changes exist in the enquiry packet responses. If there are changes in the enquiry packet responses, then the application analyzer 105 proceeds to operation S15.

If there are no changes in the enquiry packet responses, then the application analyzer 105 proceeds to operation S14, and subsequently determines whether or not there are any discrepancies within the server groups associated with each application. If there are discrepancies within the server groups associated with each application, then the application analyzer 105 proceeds to operation S15. If there are no discrepancies within the server groups associated with each application, then the application analyzer 105 returns to operation S11.

In operation S15, the application analyzer 105 detects operational irregularities in the applications. The application analyzer 105 reports any application irregularities to the IT services administrator by means of a message or screen output on the monitoring screen 110. The IT services administrator is then able to determine a course of action from the message or screen output results, and then take action according to the particular irregularity.

(Detailed Description of Monitored Application Table Generation Phase)

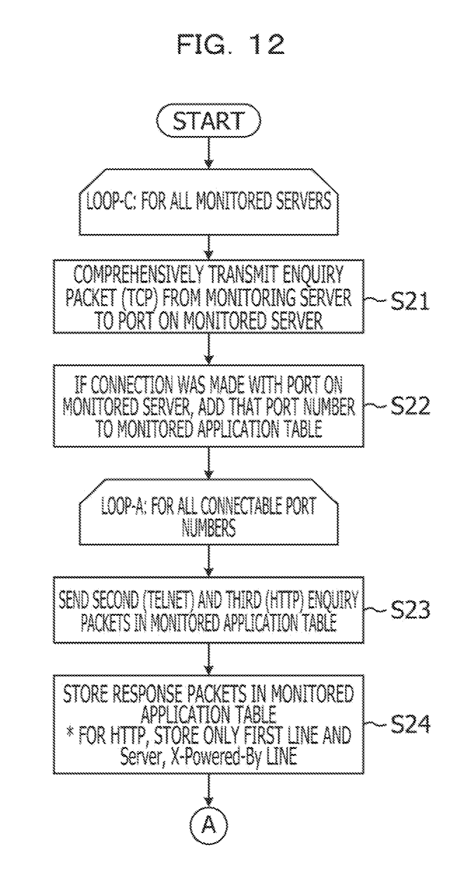

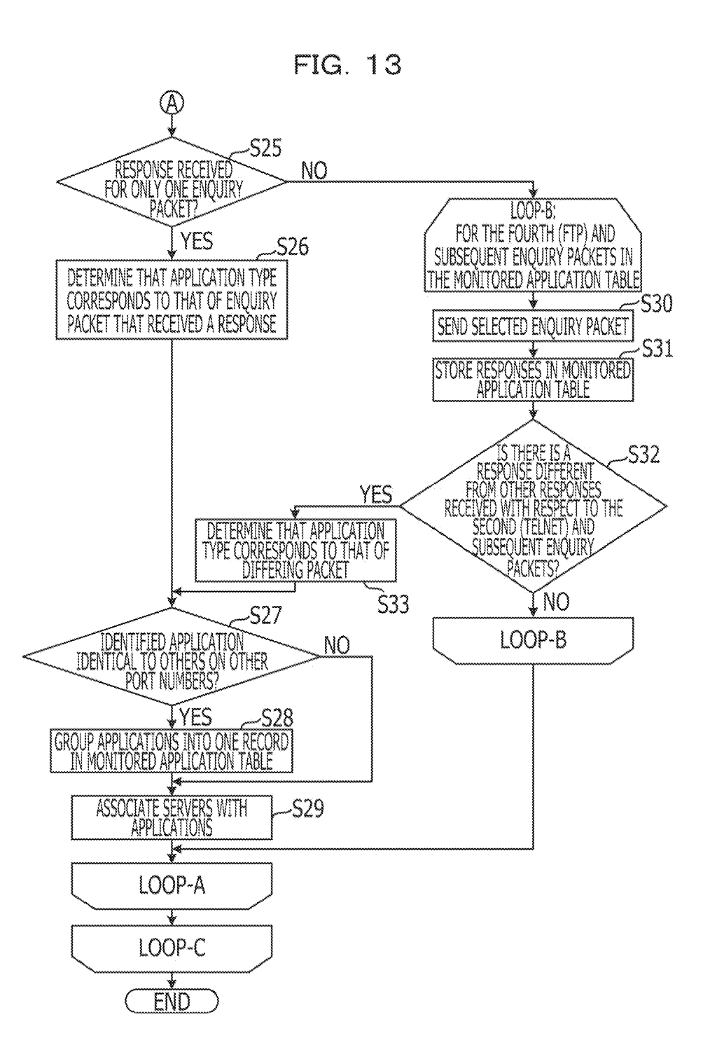

FIGS. 12 and 13 illustrate an example of a flowchart representing detailed processing operations in a monitored application table generation phase. The operations in the flowchart illustrated in FIGS. 12 and 13 are conducted for all monitored servers.

In operation S21, the enquiry packet generator/

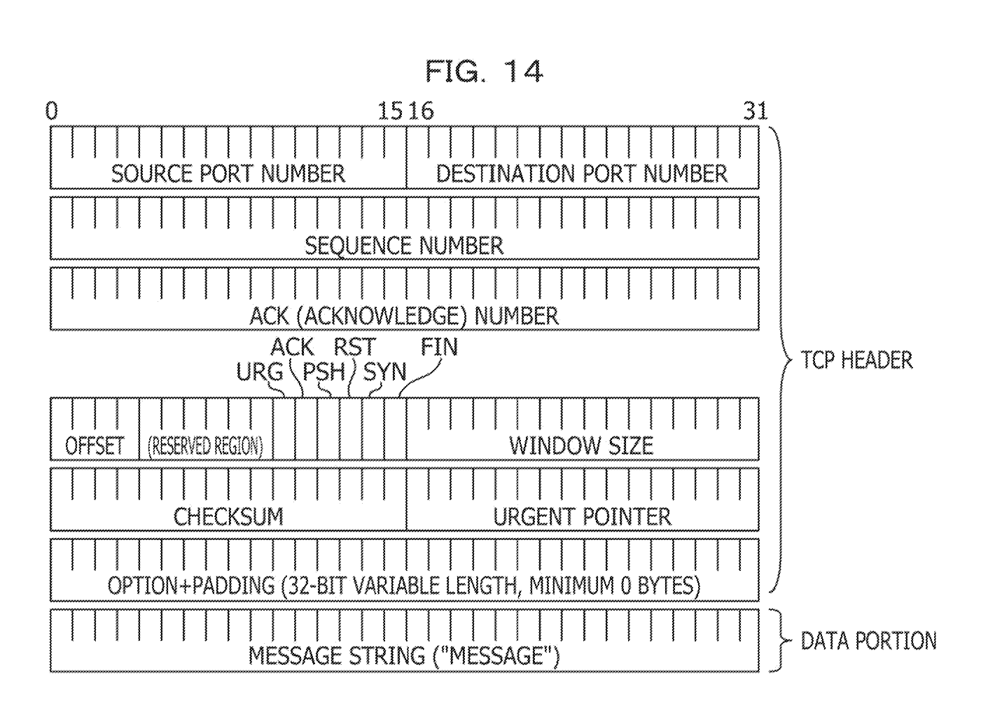

transmitter 102 generates an enquiry packet (i.e., a first enquiry packet) for a lower-layer (i.e., Transport Layer) network protocol, as illustrated in FIG. 14. FIG. 14 illustrates the structure of data expressing an enquiry packet for a lower-layer network protocol. The enquiry packet illustrated in FIG. 14 is an example of an enquiry packet for the TCP/IP protocol.

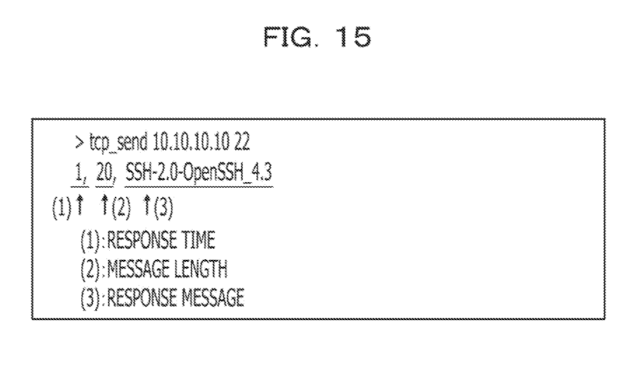

The enquiry packet generator/transmitter 102 then comprehensively transmits the generated enquiry packet to communication ports on the monitored servers. Proceeding to operation S22, the enquiry packet response receiver 103 receives an enquiry packet response like that illustrated in FIG. 15 from applications using communication ports on the monitored servers. The enquiry packet response illustrated in FIG. 15 is an example for the case of transmitting the enquiry packet illustrated in FIG. 14 to port 22 (SSH) on a server (IP address: 10.10.10.10).

The enquiry packet response illustrated in FIG. 15 is a normal response containing the following information: the response time, the message length, and the response message. An enquiry packet response may contain a normal response or an abnormal response (such as no message, no response, or an error).

The enquiry packet response receiver 103 determines that the monitored server is connectable to the port from which the normal enquiry packet response was received, and adds the port number of the connectable port to the monitored application table. For each port, the enquiry packet response receiver 103 records the content of the received TCP protocol enquiry packet response as being either “CONNECT” or “NO MESSAGE” in the monitored application table.

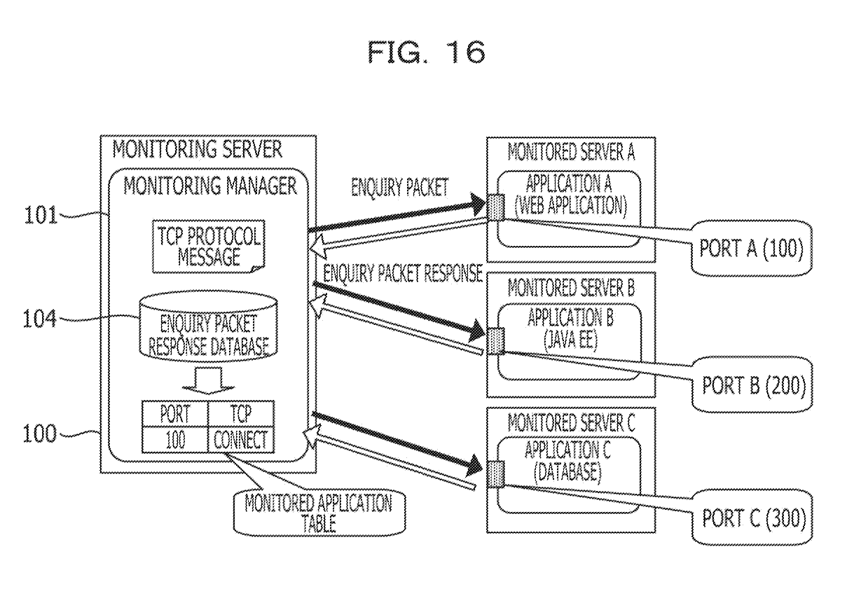

FIG. 16 illustrates an example of processing operations for generating a monitored application table when a first enquiry packet is transmitted. FIG. 16 illustrates an example wherein the enquiry packet generator/transmitter 102 transmits a first enquiry packet to respective ports on a monitored server A, a monitored server B, and a monitored server C, and wherein the enquiry packet response receiver 103 subsequently receives enquiry packet responses from port 100 on the monitored server A, port 200 on the monitored server B, and port 300 on the monitored server C.

The processing in operation S23 and thereafter in FIG. 12 is conducted for all ports that have been added to the monitored application table. Proceeding to operation S23, the application analyzer 105 requests the enquiry packet generator/transmitter 102 to transmit a Telnet enquiry packet (i.e., a second enquiry packet) as well as an HTTP enquiry packet (i.e., a third enquiry packet).

The enquiry packet generator/transmitter 102 determines the first through fifth enquiry packet network protocols in the following order: TCP, Telnet, HTTP, FTP, MySQL. This is the order of network protocols from left to right in the “Enquiry packet response” field of the monitored application table, which will be described below.

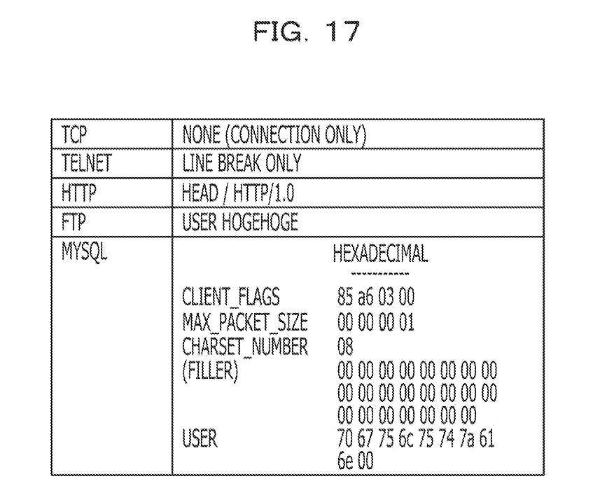

The enquiry packet generator/transmitter 102 generates a second enquiry packet having a data portion read from the table illustrated in FIG. 17 and corresponding to the second enquiry packet network protocol (Telnet). In addition, the enquiry packet generator/transmitter 102 generates a third enquiry packet having a data portion read from the table illustrated in FIG. 17 and corresponding to the third enquiry packet network protocol (HTTP).

FIG. 17 is an example of a table indicating the content of the data portion of an enquiry packet for various network protocols. The enquiry packet generator/

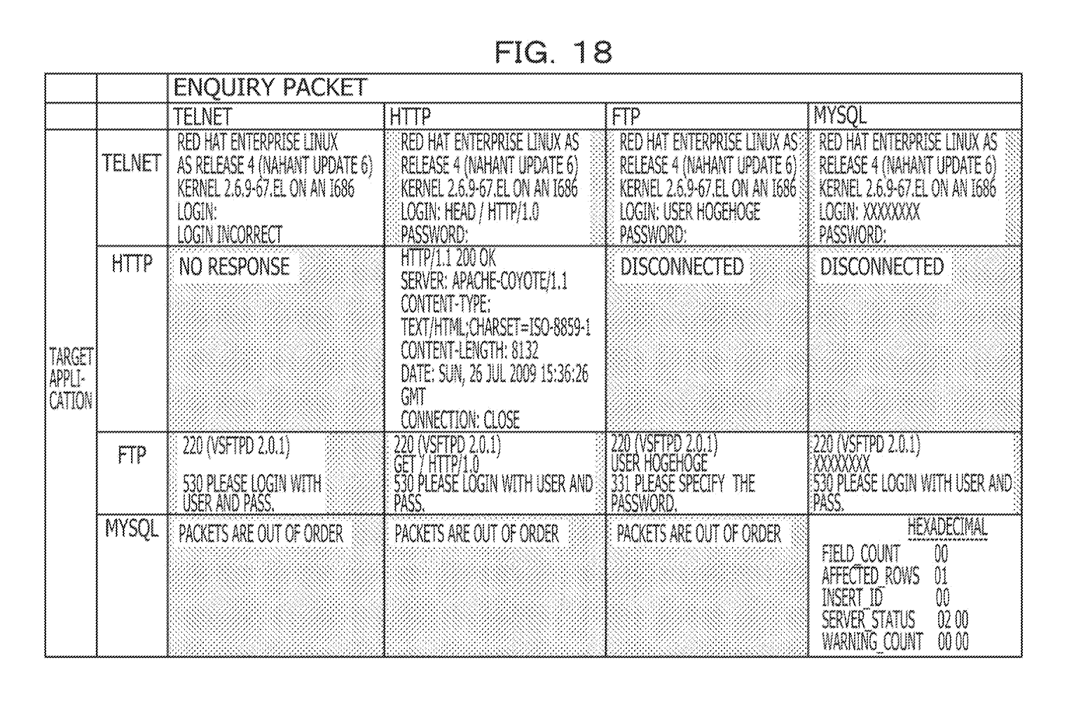

transmitter 102 transmits the generated second and third enquiry packets to the port numbers in the monitored application table. Proceeding to operation S24, the enquiry packet response receiver 103 then receives enquiry packet responses like those illustrated in FIG. 18 from applications that use the port numbers in the monitored application table.

FIG. 18 is an example of a table indicating the content of an enquiry packet response for various combinations of enquiry packet network protocols and target applications (i.e., applications using particular port numbers). When the network protocol of the enquiry packet is HTTP, variable data such as the date and size may also be included in the HTTP header of the enquiry packet response.

Thus, the information stored in the table illustrated in FIG. 18 is limited to the lines that are characteristic of the respective applications. For example, when the network protocol of the enquiry packet is HTTP, the table in FIG. 18 stores a first line as well as “Server” and “X-Powered-By” lines. In addition, the shaded portions of the table in FIG. 18 indicate enquiry packet responses for errors.

The enquiry packet response receiver 103 stores the received enquiry packet responses in the monitored application table, and in association with the particular port numbers on the monitored servers.

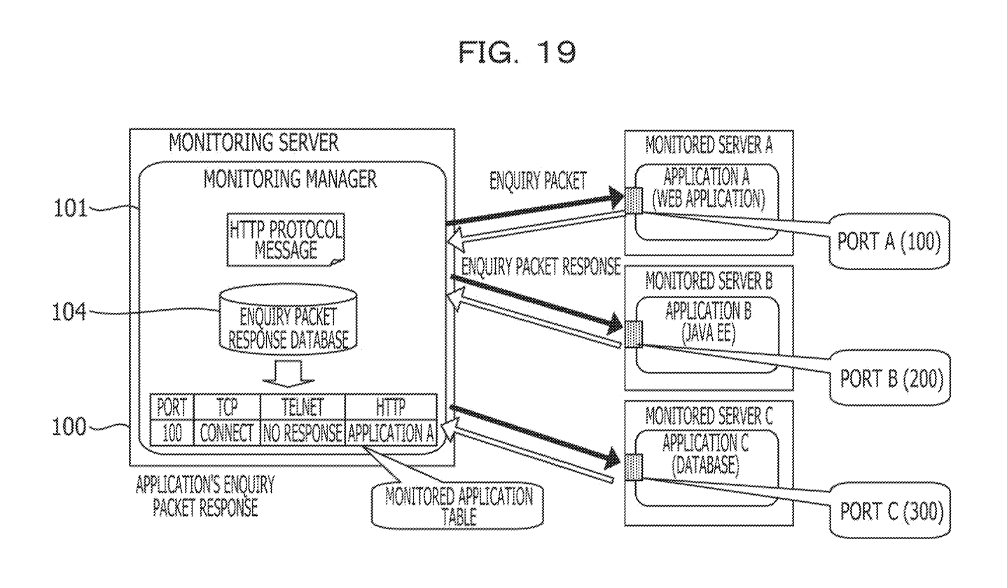

FIG. 19 illustrates an example of processing operations for generating a monitored application table when second and third enquiry packets are transmitted. FIG. 19 illustrates an example wherein the enquiry packet generator/transmitter 102 transmits second and third enquiry packets to port 100 on the monitored server A, port 200 on the monitored server B, and port 300 on the monitored server C, and wherein the enquiry packet response receiver 103 subsequently receives enquiry packet responses from port 100 on the monitored server A, port 200 on the monitored server B, and port 300 on the monitored server C. Proceeding to operation S25, the application analyzer 105 references the monitored application table, and determines whether or not an enquiry packet response was received for only one of the second and third enquiry packets.

The processing in operation S25 is conducted because some applications might not respond at all to an irrelevant packet. For example, when an enquiry packet response is received for only one of the second and third enquiry packets, the application analyzer 105 is able to determine that the application type corresponds to that of the second or third enquiry packet (i.e., the application type corresponds to the type of enquiry packet to which the application responded).

When an enquiry packet response is received for only one of the second and third enquiry packets, the application analyzer 105 proceeds to operation S26, and determines the application type to be that of either the second or third enquiry packet (whichever the application responded to).

Proceeding to operation S27, the application analyzer 105 then determines whether or not the application identified in operation S26 is the same as applications on other port numbers. If it is determined that the application identified in operation S26 is the same as applications on other port numbers, then the application analyzer 105 proceeds to operation S28. In operation S28, the application analyzer 105 groups the records for the applications identified as the same into a single application group, and then proceeds to operation S29. On the other hand, if it is determined that the application identified in operation S26 is not the same as applications on other port numbers, then the application analyzer 105 proceeds from operation S27 to operation S29.

In operation S29, the application analyzer 105 associates the application identified in operation S26 with the monitored server by adding the server name to that application's record in the monitored application table. The application analyzer 105 then returns to operation S23.

On the other hand, if there is any result in operation S25 other than receiving an enquiry packet response for only one of the second and third enquiry packets, the application analyzer 105 conducts the processing in operations S30 to S33.

Proceeding to operation S30, the application analyzer 105 requests the enquiry packet generator/transmitter 102 to transmit an FTP enquiry packet (i.e., a fourth enquiry packet).

The enquiry packet generator/transmitter 102 then generates a fourth enquiry packet having a data portion read from the table illustrated in FIG. 17 and corresponding to the fourth enquiry packet network protocol (FTP). Proceeding to operation S31, the enquiry packet response receiver 103 then receives enquiry packet responses like those illustrated in FIG. 18 from applications that use the port numbers in the monitored application table.

The enquiry packet response receiver 103 stores the received enquiry packet responses in the monitored application table, and in association with the particular port numbers on the monitored servers. Proceeding to operation S32, the application analyzer 105 refers to the monitored application table, and determines whether or not there exists a single enquiry packet response that is different from the other enquiry packet responses received with respect to the second and subsequent enquiry packets.

Since enquiry packet responses for errors are the same, the processing in operation S32 determines that the application type corresponds to that of the differing enquiry packet response when there exists an enquiry packet response that is different from the other enquiry packet responses. Thus, when a single differing enquiry packet response does exist, the application analyzer 105 proceeds to operation S33 and determines that the application type corresponds to that of the enquiry packet that received the single differing response. The process then proceeds to operation S27. If a single differing enquiry packet response does not exist, then the application analyzer 105 returns to operation S23.

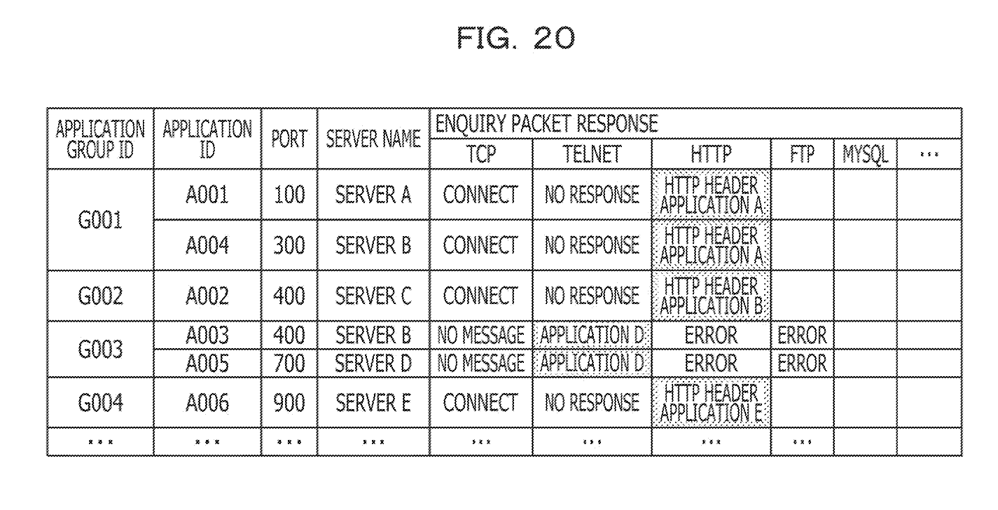

By means of the monitored application table generation phase described above, the monitoring software 101 generates a monitored application table like that illustrated in FIG. 20, and records the monitored application table in the enquiry packet response database 104. FIG. 20 illustrates one example of a monitored application table. In the monitored application table, application IDs are assigned to individual ports.

However, separate application IDs are assigned in the monitored application table in cases where the ports are identical, but the monitored servers that transmitted enquiry packet responses are different. For example, in the example illustrated in FIG. 20, the separate application IDs A002 and A003 are assigned to the same port 400. Also, depending on the content of the enquiry packet responses, application group IDs for grouping applications may be assigned in the monitored application table.

For example, in the example illustrated in FIG. 20, the application IDs A001 and A004 represent the same application “application A”, but on different ports. These application IDs A001 and A004 are thus grouped together, and assigned the application group ID G001.

The case of adding applications is also anticipated for the monitored application table illustrated in FIG. 20, and thus an application group ID is also assigned to single application IDs. The shaded portions in the monitored application table illustrated in FIG. 20 represent the particular enquiry packets by which each application can be identified. For example, the application with the application ID A001 can be identified by the enquiry packet (HTTP).

Enquiry packet destination ports, enquiry packet content, and response times are automatically managed in a table format by the monitoring software 101. In addition, the monitoring software 101 manages information by assigning a unique application ID for each port, and also assigning separate application IDs in cases where the enquiry packet responses are different.

(Detailed Description of Application Operation Monitoring Phase)

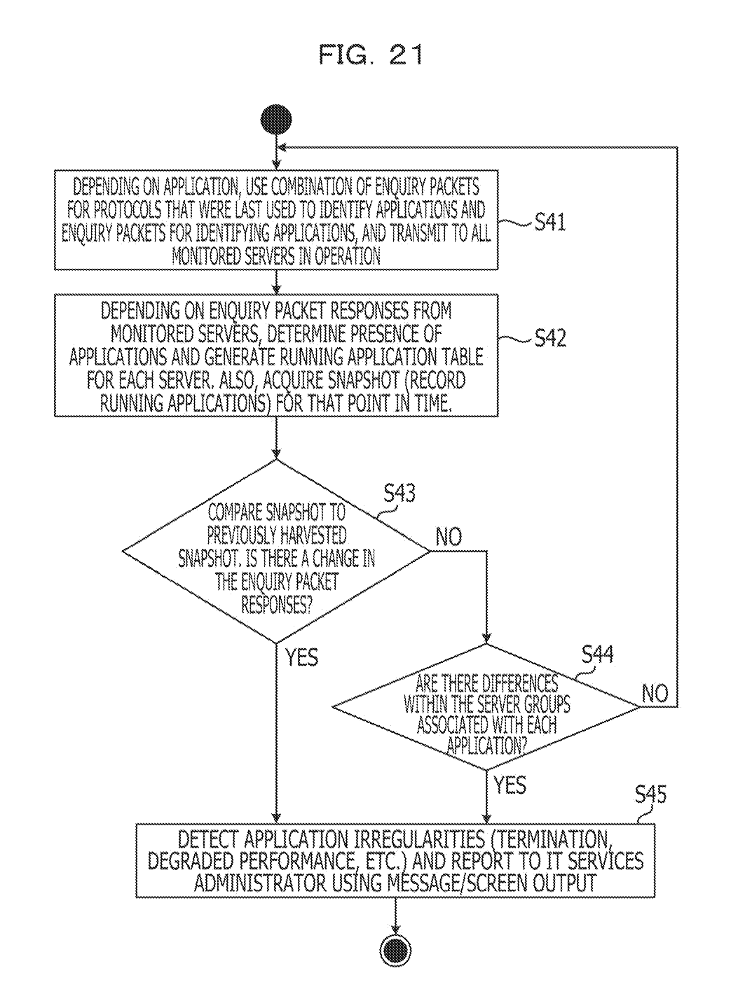

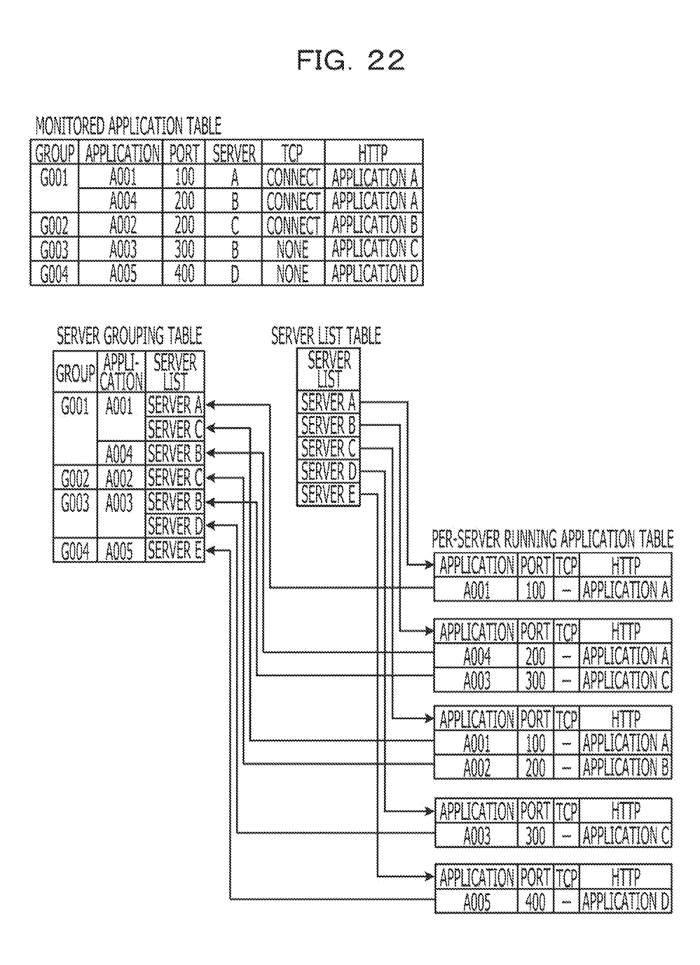

FIG. 21 is an example of a flowchart representing detailed processing operations in an application operation monitoring phase. The application operation monitoring phase is conducted at predetermined intervals. In operation S41, the application analyzer 105 requests the enquiry packet generator/transmitter 102 to transmit enquiry packets to ports on all monitored servers that are currently operating. The enquiry packets to be transmitted at this point are crafted to enable identification of applications running on the servers A to E managed in the monitored application table. The enquiry packet generator/transmitter 102 then transmits enquiry packets on the basis of the request from the application analyzer 105. Herein, the enquiry packet generator/transmitter 102 can detect the monitored servers that are currently operating from a server list table that lists the monitored servers. The server list table may, for example, be incorporated into the structure of a management table, which is illustrated in FIG. 22 and described below.

Proceeding to operation S42, the enquiry packet response receiver 103 receives enquiry packet responses from communication ports on the monitored servers. The enquiry packet response receiver 103 records the received enquiry packet responses in the enquiry packet response database 104. The application analyzer 105 then checks for the presence of applications on the monitored servers according to the enquiry packet responses recorded in the enquiry packet response database 104, and generates a running application table for each monitored server contained in the management table structure illustrated in FIG. 22. FIG. 22 illustrates an example of a structure of a management table managed by monitoring software.

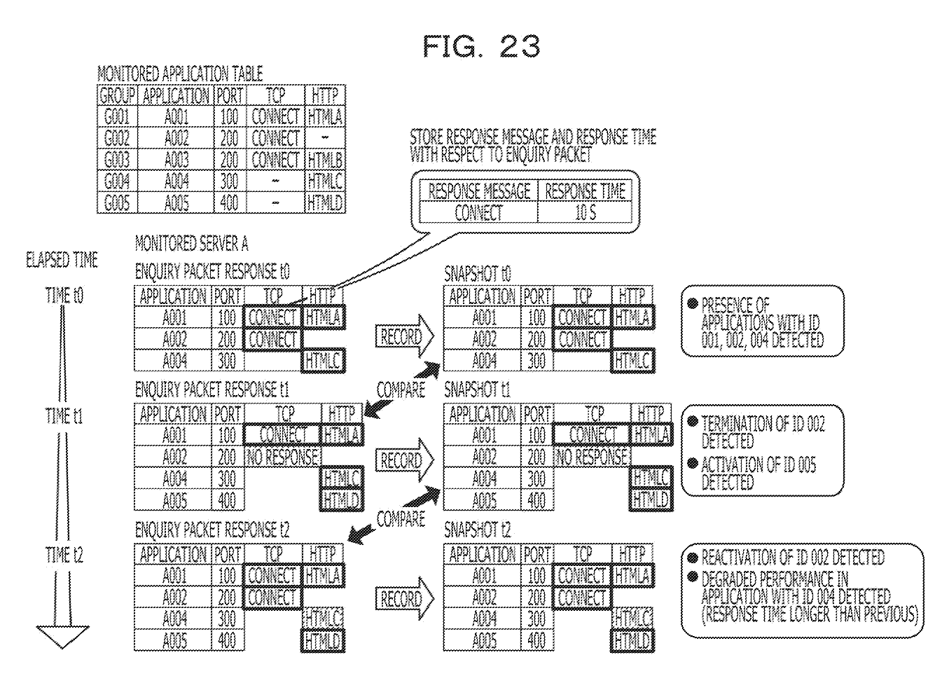

The running application tables for each monitored server at that point in time are harvested (i.e., recorded) by the application analyzer 105 for each monitored server, as illustrated in FIG. 23. FIG. 23 illustrates an example of how an operating application table and snapshots change for a monitored server A. In the example illustrated in FIG. 23, the application analyzer 105 is recording snapshots of the running application tables for the time to.

Proceeding to operation S43, the application analyzer 105 compares the enquiry packet responses received by the enquiry packet response receiver 103 to the snapshots previously harvested in operation S42, and determines whether or not the enquiry packet responses have changed.

For example, at time t1 in the example illustrated in FIG. 23, the enquiry packet responses for time t1 are compared to a snapshot of a running application table for time W. Also, at time t2, enquiry packet responses at time t2 are compared to a snapshot of a running application table for time t1.

From the comparison results at time t1, the application analyzer 105 detects that the application with the application ID A002 has stopped, while also detecting that a new application with the application ID A005 has been activated.

From the comparison results at time t2, the application analyzer 105 detects that the application with the application ID A002 has been reactivated, while also detecting degraded performance in the application with the application ID A004. Herein, degraded performance in an application can be detected by comparing the response time of the enquiry packet response with respect to an enquiry packet.

If the enquiry packet responses have changed, then the application analyzer 105 proceeds to operation S45. If the enquiry packet responses have not changed, then the application analyzer 105 proceeds to operation to S44, and subsequently determines whether or not there are any differences in the comparison results within the server groups associated with each application. The server groups associated with each application can be obtained from a server grouping table contained in the management table structure illustrated in FIG. 22. The server grouping table is for managing servers in association with applications by grouping together servers that respond with particular enquiry packet responses.

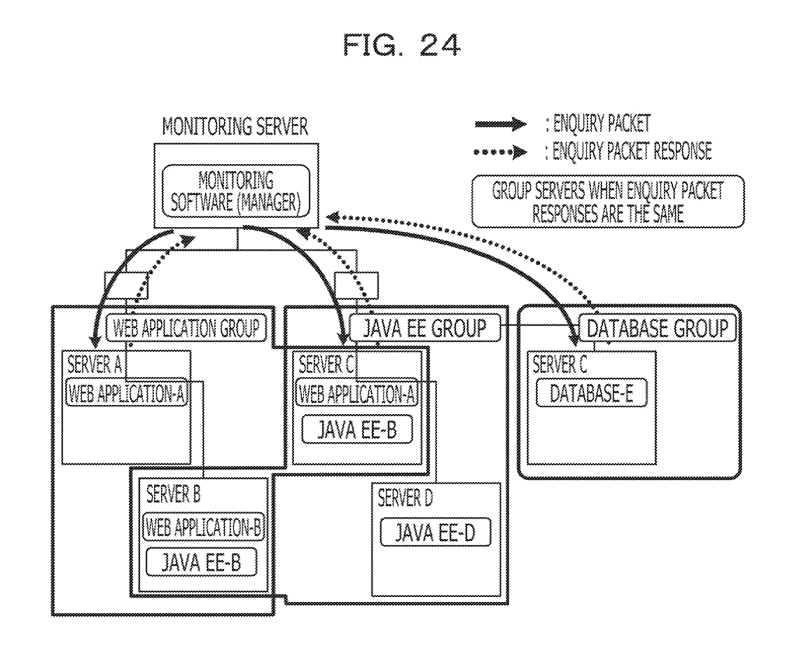

FIG. 24 illustrates a schematic example of grouping monitored servers. In FIG. 24, the servers A and B have been grouped together as a Web application group. The servers B, C, and D have been grouped together as a Java EE group. Meanwhile, the server E exists by itself in a database group.

If differences in the comparison results do exist within the server groups associated with each application, the application analyzer 105 proceeds to operation S45. If differences in the comparison results do not exist within the server groups associated with each application, then the application analyzer 105 returns to operation S41.

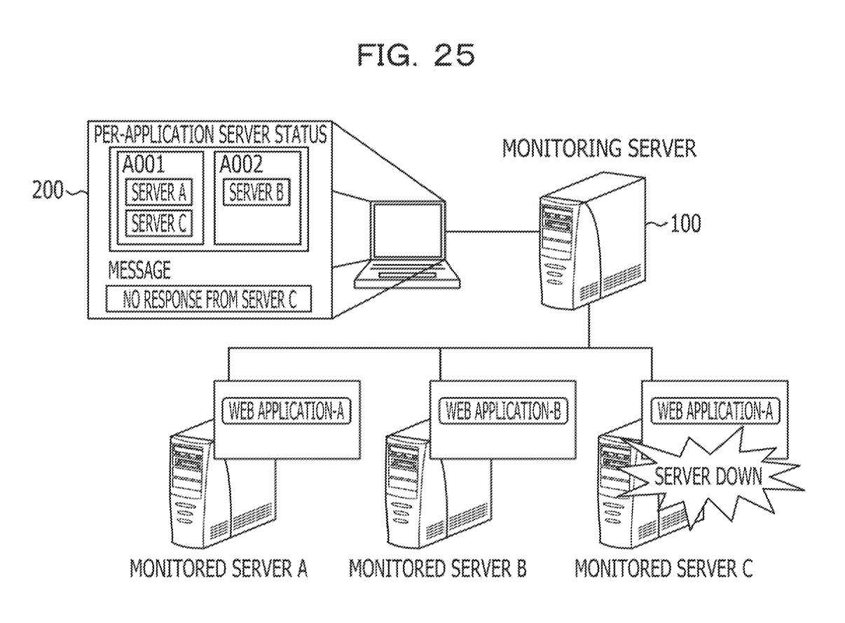

In operation S45, the application analyzer 105 detects operational irregularities in the applications, such as terminated applications and degraded performance, for example. The application analyzer 105 then reports any application irregularities to the IT services administrator by means of a message or screen output on a monitoring screen 200, as illustrated in FIG. 25.

FIG. 25 illustrates an example of a representation of a screen for notifying an administrator of operational irregularities in applications. In FIG. 25, the monitored server C has gone down, and thus the application with the application ID A001 that was running on the monitored server C has been terminated. This state is expressed by, for example, inducing a visual change on-screen (such as by changing the color), while also displaying a message indicating that the monitored server C is not responding.

The IT services administrator is then able to determine a course of action from the message or screen output results, and then take action according to the particular irregularity.

Thus, as described in the foregoing, a monitoring server 100 in accordance with an embodiment is configured to include: a means for automatically generating a monitored application table in the form of definition information for identifying business applications on monitored servers without introducing monitoring software onto the monitored servers; a means for using the monitored application table to detect whether or not applications are running on the monitored servers; and a means for ascertaining the operational status of applications by storing the applications that were running at the time of detection in a running application table, and then comparing periodic polling results to snapshots of the running application table stored earlier.

Consequently, by operating from the monitoring software 101, in accordance with the present embodiment, the monitoring server 100 is able to automatically generate a monitored application table for business applications that enable IT services, and is also able to easily monitor the IT services on monitored servers.

According to the monitoring server 100 in accordance with the present embodiment, the introduction of monitoring software on the monitored servers that run the business applications becomes unnecessary, and inconveniences such as server downtime for introducing such monitoring software may also be reduced or eliminated. Furthermore, according to the monitoring server 100 in accordance with the present embodiment, the operational status of business applications can be detected/monitored without introducing monitoring software on the monitored servers.

In addition, according to the monitoring server 100 in accordance with the present embodiment, remotely operating the monitored servers becomes unnecessary, thus reducing or eliminating any preparatory work needed by such remote operations, such as the configuration of access accounts and the modification of firewall settings. According to the monitoring server 100 in accordance with the present embodiment, since it is not necessary to remotely operate the monitored servers, the security risk of remote operation by a third party can be avoided.

Also, according to the monitoring server 100 in accordance with the present embodiment, the detection of business applications is conducted automatically, and thus it becomes unnecessary to define in advance the business applications to be searched for. According to the monitoring server 100 in accordance with the present embodiment, identical business applications (including applications that use different ports) are managed by grouping together the monitored servers where the particular business applications are installed. In so doing, checks can be made for differences among the grouped monitored servers and business applications, making it possible to more quickly discover the signs of operational irregularities in the monitored servers and the business applications.

According to the monitoring server 100 in accordance with the present embodiment, the response time from business applications is monitored (i.e., previous and current response times may be compared, or the current response time may be compared to an average of earlier response times). In so doing, the performance status of the business applications can be checked.

In addition to the above, in accordance with the present embodiment, the monitoring server 100 also does not need to expend system resources (such as CPU, memory, disk, and I/O resources) towards the monitoring software and remote commands of the related art.

Thus, according to the foregoing embodiment, it becomes possible to indirectly monitor applications remotely from an IT services monitoring system, without introducing monitoring software into the systems running the applications that implement the IT services.

Methods, apparatuses, systems, computer programs, recording media, data structures, and other technologies resulting from the application of the component elements and expressions in an embodiment disclosed herein, or arbitrary combinations thereof, are also valid modes of the disclosed embodiment.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A monitoring apparatus configured to monitor applications running on one or more monitored apparatuses; the monitoring apparatus comprising:
an enquiry packet generator and transmitter that generates multiple types of enquiry packets, and successively transmits the multiple types of enquiry packets to respective communication ports on the one or more monitored servers;
an enquiry packet response receiver that receives enquiry packet responses, which are transmitted in response to the multiple types of enquiry packets from communication ports on the one or more monitored apparatuses; and
an application analyzer that analyzes the content of the enquiry packet responses transmitted in response to the multiple types of enquiry packets, and analyzes applications running on the one or more monitored servers as applications to be monitored.

2. The monitoring apparatus according to claim 1, wherein
the enquiry packet generator and transmitter generates a first enquiry packet in the form of a lower-layer network protocol enquiry packet, and after transmitting the first enquiry packet to respective communication ports on the one or more monitored apparatuses, generates and transmits a second enquiry packet of a higher layer than the first enquiry packet, and
such second enquiry packets are successively transmitted to communication ports on the one or more monitored apparatuses from which first enquiry packet responses were received in response to the first enquiry packet, with the second enquiry packets being generated and transmitted until the applications running on the one or more monitored apparatuses have been analyzed.

3. The monitoring apparatus according to claim 1, wherein
on the basis of the results from analyzing the content of the enquiry packet responses, the application analyzer groups monitored servers running identical applications into per-application groups, and records the groups in a grouping table, and
the presence or absence of differences in the enquiry packet responses received from communication ports on the grouped monitored apparatuses is used to monitor the status of the applications running on the one or more monitored apparatuses.

4. The monitoring apparatus according to claim 1, wherein
the application analyzer instructs the enquiry packet generator/transmitter to generate specific enquiry packets for analyzed applications running on the one or more monitored apparatuses, and then transmits the specific enquiry packets to communication ports on the one or more monitored apparatuses at predetermined time intervals,
the application analyzer analyzes the content of new enquiry packet responses received by the enquiry packet response receiver in response to the specific enquiry packets, analyzes applications running on the one or more monitored apparatuses as applications to be monitored, and monitors the status of applications running on the one or more monitored apparatuses by comparing the analysis results to previous analysis results.

5. The monitoring apparatus according to claim 1, wherein the application analyzer analyzes applications running on the one or more monitored apparatuses according to the presence or absence of enquiry packet responses with respect to the multiple types of enquiry packets, the content of messages included in the enquiry packet responses, and enquiry packet response errors.

6. A monitoring method executed by a computer, the monitoring method comprising:
generating multiple types of enquiry packets, and successively transmitting the multiple types of enquiry packets to respective communication ports on one or more monitored servers;
receiving enquiry packet responses, which are transmitted in response to the multiple types of enquiry packets from communication ports on the one or more monitored apparatuses; and
analyzing the content of the enquiry packet responses transmitted in response to the multiple types of enquiry packets, and analyzing applications running on the one or more monitored servers as applications to be monitored.

7. A non-transitory computer readable recording medium storing a monitoring program that monitors applications running on one or more monitored apparatuses, the monitoring program causing a computer to execute a process, the process comprising:
generating multiple types of enquiry packets, and successively transmitting the multiple types of enquiry packets to respective communication ports on the one or more monitored servers;
receiving enquiry packet responses, which are transmitted in response to the multiple types of enquiry packets from communication ports on the one or more monitored apparatuses; and
analyzing the content of the enquiry packet responses transmitted in response to the multiple types of enquiry packets, and analyzing applications running on the one or more monitored servers as applications to be monitored.
